(19) United States
(12) Patent Application Publication
(10) Pub. No.: US 2017/0275430 A1
(43) Pub. Date: Sep. 28, 2017

(54) COMPOSITE SEMI-FINISHED PRODUCTS, MOLDED PARTS PRODUCED THEREFROM, AND DIRECTLY PRODUCED MOLDED PARTS BASED ON HYDROXY-FUNCTIONALIZED (METH)ACRYLATES AND URETDIONES THAT ARE CROSS-LINKED IN A THERMOSETTING MANNER

(71) Applicants: Michael KUBE, Haltern am See (DE); Zuhal TUNCAY, Herne (DE); Sandra REEMERS, Muenster (DE); Friedrich Georg SCHMIDT, Haltern am See (DE); Emmanouil SPYROU, Schermbeck (DE)

(72) Inventors: Michael KUBE, Haltern am See (DE); Zuhal TUNCAY, Herne (DE); Sandra REEMERS, Muenster (DE); Friedrich Georg SCHMIDT, Haltern am See (DE); Emmanouil SPYROU, Schermbeck (DE)

(73) Assignee: Evonik Degussa GmbH, Essen (DE)

(21) Appl. No.: 15/509,294

(22) PCT Filed: Sep. 1, 2015
(86) PCT No.: PCT/EP2015/069882

§ 371 Date: Mar. 7, 2017

(30) Foreign Application Priority Data
Sep. 8, 2014 (EP) 14183881.3

(51) Int. Cl. C08J 5/24; B29C 70/06

(52) U.S. Cl. CPC C08J 5/24; B29C 70/06; C08J 3/243

(57) ABSTRACT

The invention relates to a process for producing storage-stable polyurethane prepregs and mouldings produced therefrom (composite components). For production of the prepregs or components, for example, (meth)acrylate monomers, (meth)acrylate polymers, hydroxy-functionalized (meth)acrylate monomers and/or hydroxy-functionalized (meth)acrylate polymers are mixed with non-(meth)acrylic polyols and with uretdione materials. This mixture or solution is applied to fibre material, for example carbon fibres, glass fibres or polymer fibres, by known methods and polymerized thermally, via a redox initiation or with the aid of radiation or plasma applications.

Polymerization, for example at room temperature or at up to 80° C., gives rise to thermoplastics or thermoplastic prepregs which can subsequently be subjected to a forming operation. The hydroxy-functionalized (meth)acrylate constituents and the polyols can subsequently be crosslinked with the uretdiones already present in the system by means of elevated temperature. In this way, dimensionally stable thermosets or crosslinked composite components can be produced.

### FIELD OF THE INVENTION

The invention relates to a process for producing storage-stable polyurethane prepregs and mouldings produced therefrom (composite components). For production of the prepregs or components, for example, (meth)acrylate monomers, (meth)acrylate polymers, hydroxy-functionalized (meth)acrylate monomers and/or hydroxy-functionalized (meth)acrylate polymers are mixed with non-(meth)acrylic polyols and with uretdione materials. This mixture or solution is applied to fibre material, for example carbon fibres, glass fibres or polymer fibres, by known methods and polymerized thermally, via a redox initiation or with the aid of radiation or plasma applications.

Polymerization, for example at room temperature or at up to 80° C., gives rise to thermoplastics or thermoplastic prepregs which can subsequently be subjected to a forming operation. The hydroxy-functionalized (meth)acrylate constituents and the polyols can subsequently be crosslinked with the uretdiones already present in the system by means of elevated temperature. In this way, dimensionally stable thermosets or crosslinked composite components can be produced.

Fibre-reinforced materials in the form of prepregs are already being used in many industrial applications because of their convenience of handling and the increased efficiency in processing compared to the alternative wet-layup methodology.

Industrial users of such systems, in addition to faster cycle times and higher storage stabilities—even at room temperature—are also demanding a way of cutting the prepregs to size, without contamination of the cutting tools with the often sticky matrix material in the course of automated cutting-to-size and laying-up of the individual prepreg layers.

Various moulding processes, for example the reaction transfer moulding (RTM) process, involve the introduction of the reinforcing fibres into a mould, the closing of the mould, the introduction of the crosslinkable resin formulation into the mould, and the subsequent crosslinking of the resin, typically by supplying heat.

One of the limitations of such a process is the relative difficulty in laying the reinforcing fibres into the mould. The individual layers of the woven fabric or laid scrim have to be cut to size and matched to the different mould geometries. This can be both time-consuming and complicated, especially when the mouldings are also to contain foam cores or other cores. Preformable fibre reinforcements with simple handling and existing forming options would be desirable here.

### State of the Art

As well as polyesters, vinyl esters and epoxy systems, there are a number of specialized resins in the field of crosslinking matrix systems. These also include polyurethane resins which, because of their toughness, damage tolerance and strength, are used particularly for production of composite profiles via pultrusion processes. A disadvantage frequently mentioned is the toxicity of the isocyanates used. However, the toxicity of epoxy systems and the curing components used therein should also be regarded as critical. This is especially true of known sensitizations and allergies.

Prepregs and composites produced therefrom that are based on epoxy systems are described, for example, in WO 98/50211, EP 309 221, EP 297 674, WO 89/04335 and U.S. Pat. No. 4,377,657. WO 2006/043019 describes a method for production of prepregs based on epoxy resin-polyurethane powders. Additionally known are prepregs based on pulverulent thermoplastics as matrix.

WO 99/64216 describes prepregs and composites and a method for production thereof, in which emulsions having polymer particles so small as to enable single fibre coating are used. The polymers of the particles have a viscosity of at least 5000 centipoise and are either thermoplastics or crosslinking polyurethane polymers.

EP 0 590 702 describes powder impregnations for production of prepregs, in which the powder consists of a mixture of a thermoplastic and a reactive monomer or prepolymer. WO 2005/091715 also describes the use of thermoplastics for production of prepregs.

Prepregs having a matrix based on two-component polyurethanes (2-K PUR) are likewise known. The 2-K PUR category essentially comprises the conventional reactive polyurethane resin systems. In principle, this is a system consisting of two separate components. While the critical constituent of one component is always a polyisocyanate, for example polymeric methylenediphenyl diisocyanates (MDI), the critical constituent in the second component comprises polyols or in more recent developments also amino- or amine-polyol mixtures. The two parts are mixed together only shortly before processing. Thereafter, the chemical curing takes place through polyaddition with formation of a network of polyurethane or polyurea. After the mixing of the two constituents, two-component systems have a limited processing period (service life, pot life), since the onset of reaction leads to a gradual increase in viscosity and finally to gelation of the system. Many variables determine its effective processibility period: reactivity of the co-reactants, catalysis, concentration, solubility, moisture content, NCO/OH ratio and ambient temperature are the most important [see: Lackharze (Coating Resins), Stoye/Freitag, Hauser-Verlag 1996, pages 210/212]. The disadvantage of the prepregs based on such 2-K PUR systems is that only a short period is available for processing of the prepreg to a composite. Therefore, such prepregs are not storage-stable over a number of hours, let alone days.

Apart from the different binder basis, moisture-curing coating materials correspond to largely analogous 2K systems both in terms of composition and in terms of properties. In principle, the same solvents, pigments, fillers and auxiliaries are used. Unlike 2K coatings, for stability reasons, these systems do not tolerate any moisture at all before their application.

DE 102009001793.3 and DE 102009001806.9 describe a method for production of storage-stable prepregs, essentially composed of A) at least one fibrous carrier and B) at least one reactive pulverulent polyurethane composition as matrix material.

These systems may also contain poly(meth)acrylates as co-binder or polyol component. In DE 102010029355.5, such compositions are introduced into the fibre material by a direct melt impregnation process. In DE 102010030234.1, this is effected by a pretreatment with solvents. Disadvantages of these systems are the high melt viscosity or the use of solvents, which have to be removed in the intervening period, or else can entail disadvantages from a toxicological point of view.

International patent application PCT/EP2014/053705 discloses the combination of a (meth)acrylate reactive resin and a blocked isocyanate component. This involves impregnating a fibre material with this composition and then curing the reactive resin by means of radiation. This prepreg can then be formed before the isocyanate component is cured. However, a disadvantage in this system has been found to be that the necessary melt viscosity for the further processing of the prepreg at the required crosslinking temperatures is generally very high. The result of this is that very high pressures have to be set, or otherwise the quality and mechanical properties of the composite are inadequate.

EP 2 661 459 discloses an analogous system with curing of the resin component using thermal or redox initiators. This system has the same disadvantages as the system described in European application PCT/EP2014/053705. In addition, the curing mechanism results in a distinct loss of monomers in the resin component, which is disadvantageous for reasons of emission prevention alone.

### Problem

Against the background of the prior art, the problem addressed by the present invention was that of providing a novel prepreg technology which enables a simpler process for production of prepreg systems which can be handled without difficulty and are particularly simple to produce.

A particular problem addressed by the present invention was that of providing an accelerated process for production of prepregs, which enables distinctly prolonged storage stability and/or processing time (service life, pot life) compared to the prior art. In addition, the composition for production of prepregs is to have a melt viscosity which is particularly easy to process, i.e. a low melt viscosity.

A further problem addressed was that of enabling mouldings having particularly high quality and very good mechanical properties as a subsequent product of these prepregs. These are to be producible and processible in a particularly simple manner and without any exceptional capital costs in moulds required for the purpose.

### Solution

The problems are solved by means of a novel process for producing semi-finished composites and further processing thereof to give mouldings, wherein a composition comprising at least one (meth)acrylate-based resin component, at least one polyol and at least one isocyanate component is used in this process. This novel process has the following process steps:

I. producing a reactive composition comprising a composition, said composition comprising at least A) a reactive (meth)acrylate-based resin component, where at least one constituent of the resin component has hydroxyl, amine and/or thiol groups, B) at least one di- or polyisocyanate which has been internally blocked and/or blocked with blocking agents as isocyanate component and C) one or more polyols which are not (meth)acrylates or poly(meth)acrylates. Process step I can be effected, for example, by simply stirring the three components together.

II. directly impregnating a fibrous carrier with the composition from I.,

III. curing the resin component in the composition by means of thermal initiation, redox initiation of a two-component system, electromagnetic radiation, electron beams or a plasma,

IV. shaping to give the later moulding and

V. curing the isocyanate component in the composition.

Preferably, the composition comprises 25% to 85% by weight, preferably 30% to 70% by weight, more preferably 40% to 60% by weight, of the resin component, 10% to 60% by weight, preferably 15% of 55% by weight, more preferably 20% to 50% by weight, of the isocyanate component, and 3% by weight to 40% by weight, preferably 5% to 30% by weight, more preferably 7% to 20% by weight, of one or more polyols.

Most preferably, the resin component, the polyols and the isocyanate component are present in such a ratio to one another that there is 0.3 to 1.0, preferably 0.4 to 0.9, more preferably 0.45 to 0.55, uretdione group—corresponding to 0.6 to 2.0, preferably 0.8 to 1.8 and more preferably 0.9 to 1.1 externally blocked isocyanate groups in the isocyanate component—for each hydroxyl group in the resin component and the polyols.

The resin component is especially at least composed of 0% to 30% by weight, preferably 1% to 15% by weight and more preferably 2% to 10% by weight of crosslinkers, preferably di- or tri(meth)acrylates, 30% to 100% by weight, preferably 40% to 80% by weight and more preferably 40% to 60% by weight of monomers, preferably (meth)acrylate monomers, 0% to 40% by weight, preferably 5% to 30% by weight, of one or more poly(meth)acrylates, and 0% to 10% by weight, preferably 0.5% to 8% by weight and more preferably 3% to 6% by weight of photoinitiators, peroxide and/or azo initiator. The photoinitiator preferably comprises hydroxy ketones and/or bisacylphosphines. The peroxides may, for example, be dilauroyl peroxide and/or dibenzoyl peroxide. One example of an azo initiator is AIBN.

The advantage of this system according to the invention lies in the production of a formable thermoplastic semi-finished product/prepreg which is crosslinked to give a thermoset material in a further step in the production of the composite components. The starting formulation is liquid and hence suitable for the impregnation of fibre material without addition of solvents. The semi-finished products are storage-stable at room temperature. The resultant mouldings have elevated heat distortion resistance compared to other polyurethane systems. Compared to standard epoxy systems, they are notable for higher flexibility. In addition, such matrices can be laid out in light-stable form and hence can be used for the production of carbon fibre-wrapped parts without further painting.

It has been found that, surprisingly, adequately impregnated, reactive and storage-stable semi-finished composites can be produced by producing them with the abovementioned combination of a (meth)acrylate reactive resin, polyols and an isocyanate component.

This affords semi-finished composites having at least the same or even improved processing properties compared to the prior art, which are usable for the production of high-performance composites for a wide variety of different applications in the construction, automotive and aerospace sectors, in the energy industry (wind turbines) and in boat- and shipbuilding. The reactive compositions usable in accordance with the invention are environmentally friendly and inexpensive, have good mechanical properties, are easy to process and feature good weathering resistance after curing and a balanced ratio of hardness to flexibility.

Another surprising finding was that, when tri- to hexafunctional polyols were used, it was possible to improve the quality of the laminates and components produced from the prepregs. In addition, it was possible to distinctly lower the pressure in the compression mould, which enables the use of a much less expensive mould or a simpler press.

In addition, in terms of the mechanical properties, an improvement in interlaminar shear strength was surprisingly achieved.

Moreover, a prepreg according to the invention has a lower glass transition temperature of the matrix material. Thus, better flexibility of the dry semi-finished product is achieved, which in turn facilitates further processing. However, the thermal stability of the crosslinked component was surprisingly maintained, compared to a prior art system with no polyols.

More particularly, it has been found that, surprisingly, the mixture comprising the resin component and at least one polyol has a particularly low melt viscosity compared to the prior art, especially compared to systems including only the resin component or only polyols.

In the context of this invention, the term “semi-finished composite” is used synonymously with the terms “prepreg” and “organic sheet”. A prepreg is generally a precursor of thermoset composite components. An organic sheet is normally a corresponding precursor of thermoplastic composite components.

In a particular embodiment, the resin component additionally comprises urethane (meth)acrylates. In such an embodiment, the resin component is composed of 0% to 30% by weight, preferably 1% to 15% by weight and more preferably 2% to 10% by weight of crosslinkers, 30% to 99% by weight, preferably 40% to 80% by weight and more preferably 40% to 60% by weight of monomers, 0% to 40% by weight, preferably 5% to 30% by weight, of one or more prepolymers, 1% to 20% by weight, preferably 2% to 10% by weight and more preferably 4% to 8% by weight of urethane (meth)acrylates, and 0% to 10% by weight, preferably 0.5% to 8% by weight and more preferably 3% to 6% by weight of photoinitiators, peroxides and/or azo initiators.

The photoinitiators, peroxides and/or azo initiators, if they are added, are present in the composition in a concentration between 0.2% and 10.0% by weight, preferably between 0.5% and 8% by weight and more preferably 3% to 6% by weight.

### Carrier

The carrier material used with preference in the semi-finished composite product in the process according to the invention is characterized in that the fibrous carriers consist for the most part of glass, carbon, polymers such as polyamide (aramid) or polyesters, natural fibres, or mineral fibre materials such as basalt fibres or ceramic fibres. The fibrous carriers take the form of sheetlike textile structures made from nonwoven fabric, of knitted fabric including loop-formed and loop-drawn knits, of non-knitted structures such as woven fabrics, laid scrims or braids, or of long-fibre or short-fibre materials.

The detailed execution is as follows: The fibrous carrier in the present invention consists of fibrous material (also often called reinforcing fibres). Any material that the fibres consist of is generally suitable, but preference is given to using fibrous material made of glass, carbon, plastics such as polyamide (aramid) or polyester, natural fibres, or mineral fibre materials such as basalt fibres or ceramic fibres (oxidic fibres based on aluminium oxides and/or silicon oxides). It is also possible to use mixtures of fibre types, for example woven fabric combinations of aramid and glass fibres, or carbon and glass fibres. It is likewise possible to produce hybrid composite components with prepregs made from different fibrous carriers.

Mainly because of their relatively low cost, glass fibres are the most commonly used fibre types. In principle, all kinds of glass-based reinforcing fibres are suitable here (E glass, S glass, R glass, M glass, C glass, ECR glass, D glass, AR glass, or hollow glass fibres). Carbon fibres are generally used in high performance composite materials, where another important factor is the lower density compared to glass fibres with simultaneously high strength. Carbon fibres are industrially produced fibres composed of carbonaceous starting materials which are converted by pyrolysis to carbon in a graphite-like arrangement. A distinction is made between isotropic and anisotropic types: isotropic fibres have only low strengths and lower industrial significance; anisotropic fibres exhibit high strengths and rigidities with simultaneously low elongation at break. Natural fibres refer here to all textile fibres and fibrous materials which are obtained from plant and animal material (for example wood fibres, cellulose fibres, cotton fibres, hemp fibres, jute fibres, flax fibres, sisal fibres and bamboo fibres). Similarly to carbon fibres, aramid fibres exhibit a negative coefficient of thermal expansion, i.e. become shorter on heating. Their specific strength and their modulus of elasticity are markedly lower than those of carbon fibres. In combination with the positive coefficient of expansion of the matrix resin, it is possible to produce components of high dimensional stability. Compared to carbon fibre-reinforced plastics, the compressive strength of aramid fibre composite materials is much lower. Known brand names of aramid fibres are Nomex® and Kevlar® from DuPont, or Teijinconex®, Twaron® and Technora® from Teijin. Particularly suitable and preferred carriers are those made of glass fibres, carbon fibres, aramid fibres or ceramic fibres. The fibrous material is a sheetlike textile structure. Suitable materials are sheetlike textile structures made from nonwoven fabric, and likewise knitted fabric including loop-formed and loop-drawn knits, but also non-knitted fabrics such as woven fabrics, laid scrims or braids. In addition, a distinction is made between long-fibre and short-fibre materials as carriers. Likewise suitable in accordance with the invention are rovings and yarns. In the context of the invention, all the materials mentioned are suitable as fibrous carriers. There is an overview of reinforcing fibres in “Composites Technologien” [Composites Technologies], Paolo Ermanni (Version 4), Script for lecture at ETH Zurich, August 2007, Chapter 7.

### Isocyanate Component

Isocyanate components used, as the first embodiment, are di- and polyisocyanates blocked with blocking agents or, as the second embodiment, internally blocked di- and polyisocyanates. The internally blocked isocyanates are what are called uretdiones.

The di- and polyisocyanates used in accordance with the invention may consist of any desired aromatic, aliphatic, cycloaliphatic and/or (cyclo)aliphatic di- and/or polyisocyanates. A list of possible di- and polyisocyanates and reagents for external blocking thereof can be found in German patent application DE 102010030234.1.

The polyisocyanates used in accordance with the invention, in a first embodiment, are externally blocked. External blocking agents are useful for this purpose, as found, for example, in DE 102010030234.1. The di- or polyisocyanates used in this embodiment are preferably hexamethylene diisocyanate (HDI), diisocyanatodicyclohexylmethane (H₁₂MDI), 2-methylpentane diisocyanate (MPDI), 2,2,4-trimethylhexamethylene diisocyanate/2,4,4-trimethylhexamethylene diisocyanate (TMDI) and/or norbornane diisocyanate (NBDI), and it is also possible to use the isocyanurates. Preferred blocking agents are selected from ethyl acetoacetate, diisopropylamine, methyl ethyl ketoxime, diethyl malonate, ε-caprolactam, 1,2,4-triazole, phenol or substituted phenols and/or 3,5-dimethylpyrazole. The curing components used with particular preference are isophorone diisocyanate (IPDI) adducts containing isocyanurate moieties and ε-caprolactam-blocked isocyanate structures.

In addition, the isocyanate component may contain 0.01% to 5.0% by weight of catalysts. Catalysts used are preferably organometallic compounds such as dibutyltin dilaurate, zinc octoate or bismuth neodecanoate, and/or tertiary amines, more preferably 1,4-diazabicyclo[2.2.2]octane. Tertiary amines are especially used in concentrations between 0.001% and 1% by weight. These reactive polyurethane compositions used in accordance with the invention can be cured, for example, under standard conditions, for example with DBTL catalysis, at or above 160° C., typically at or above about 180° C.

In a second, preferred embodiment, the isocyanate components have been internally blocked. The internal blocking is effected via dimer formation via uretdione structures which, at elevated temperature, are dissociated back to the isocyanate structures originally present and hence set in motion the crosslinking with the binder.

Polyisocyanates containing uretdione groups are well-known and are described, for example, in U.S. Pat. No. 4,476,054, U.S. Pat. No. 4,912,210, U.S. Pat. No. 4,929,724 and EP 417 603. A comprehensive overview of industrially relevant methods for dimerization of isocyanates to uretdiones is given by J. Prakt. Chem. 336 (1994) 185-200. In general, isocyanates are converted to uretdiones in the presence of soluble dimerization catalysts, for example dialkylaminopyridines, trialkylphosphines, phosphoramides or imidazoles. The reaction, optionally conducted in solvents, but preferably in the absence of solvents, is stopped—by addition of catalyst poisons—on attainment of a desired conversion. Excess isocyanate monomer is subsequently separated off by short-path evaporation. If the catalyst is sufficiently volatile, the reaction mixture may be freed of the catalyst in the course of monomer removal. It is possible to dispense with the addition of catalyst poisons in this case. In principle, there is a wide range of isocyanates suitable for preparing polyisocyanates containing uretdione groups. It is possible to use the abovementioned di- and polyisocyanates.

Both for the embodiment of the externally blocked isocyanates and for the embodiment of the uretdiones, preference is given to di- and polyisocyanates formed from any desired aliphatic, cycloaliphatic and/or (cyclo)aliphatic di- and/or polyisocyanates. The invention uses isophorone diisocyanate hexamethylene diisocyanate (HDI), diisocyanatodicyclohexylmethane (H₁₂MDI), 2-methylpentane diisocyanate (MPDI), 2,2,4-trimethylhexamethylene diisocyanate/2,4,4-trimethylhexamethylene diisocyanate (TMDI), norbornane diisocyanate (NBDI). Very particular preference is given to using IPDI, HDI, TMDI and H₁₂MDI, and it is also possible to use the isocyanurates.

Very particular preference is given to using IPDI and/or HDI for the matrix material. The reaction of these polyisocyanates containing uretdione groups to give curing agents a) containing uretdione groups comprises the reaction of the free NCO groups with hydroxyl-containing monomers or polymers, for example polyesters, polythioethers, polyethers, polycaprolactams, polyepoxides, polyesteramides, polyurethanes or low molecular weight di-, tri- and/or tetraalcohols as chain extenders, and optionally monoamines and/or monoalcohols as chain terminators, and has already been described frequently (EP 669 353, EP 669 354, DE 30 30 572, EP 639 598 or EP 803 524).

Preferred curing agents a) having uretdione groups have a free NCO content of less than 5% by weight and a content of uretdione groups of 3% to 25% by weight, preferably 6% to 18% by weight (calculated as C₂N₂O₂, molecular weight 84). Preference is given to polyesters and monomeric dialcohols. Apart from the uretdione groups, the curing agents may also have isocyanurate, biuret, allophanate, urethane and/or urea structures.

The isocyanate component is preferably in solid form below 40° C. and in liquid form above 125° C. Optionally, the isocyanate component may contain further auxiliaries and additives known from polyurethane chemistry. In relation to the uretdione-containing embodiment, the isocyanate component has a free NCO content of less than 5% by weight and a uretdione content of 3% to 50% by weight, preferably to 25% by weight.

In addition, the isocyanate composition of this embodiment may contain 0.01% to 5% by weight, preferably 0.3% to 2% by weight, of at least one catalyst selected from quaternary ammonium salts, preferably tetraalkylammonium salts, and/or quaternary phosphonium salts with halogens, hydroxides, alkoxides or organic or inorganic acid anions as counterion, and 0.1% to 5% by weight, preferably 0.3% to 2% by weight, of at least one cocatalyst selected from at least one epoxide and/or at least one metal acetylacetonate and/or quaternary ammonium acetylacetonate and/or quaternary phosphonium acetylacetonate. All amounts stated for the (co-)catalysts are based on the overall formulation of the matrix material.

Examples of metal acetylacetonates are zinc acetylacetonate, lithium acetylacetonate and tin acetylacetonate, alone or in mixtures. Preference is given to using zinc acetylacetonate.

Examples of quaternary ammonium acetylacetonates or quaternary phosphonium acetylacetonates can be found in DE 102010030234.1. Particular preference is given to using tetraethylammonium acetylacetonate and tetrabutylammonium acetylacetonate. It is of course also possible to use mixtures of such catalysts.

Examples of the catalysts can be found in DE 102010030234.1. These catalysts may be added alone or in mixtures. Preference is given to using tetraethylammonium benzoate and tetrabutylammonium hydroxide.

Useful epoxy-containing cocatalysts include, for example, glycidyl ethers and glycidyl esters, aliphatic epoxides, diglycidyl ethers based on bisphenol A, and glycidyl methacrylates. Examples of such epoxides are triglycidyl isocyanurate (TGIC, trade name: ARALDIT 810, Huntsman), mixtures of diglycidyl terephthalate and triglycidyl trimellitate (trade name: ARALDIT PT 910 and 912, Huntsman), glycidyl esters of Versatic acid (trade name: KARDURA E10, Shell), 3,4-epoxycyclohexylmethyl 3′,4′-epoxycyclohexanecarboxylate (ECC), diglycidyl ethers based on bisphenol A (trade name: EPIKOTE 828, Shell), ethylhexyl glycidyl ether, butyl glycidyl ether, pentaerythrityl tetraglycidyl ether (trade name: POLYPOX R 16, UPPC AG), and other Polypox products having free epoxy groups. It is also possible to use mixtures. Preference is given to using ARALDIT PT 910 and 912.

According to the composition of the reactive or highly reactive isocyanate component used and of any catalysts added, it is possible to vary the rate of the crosslinking reaction in the production of the composite components and the properties of the matrix within wide ranges.

### Resin Components

According to the invention, resin components used are methacrylate-based reactive resins. The resin component used in accordance with the invention especially has the following composition:
30% to 100% by weight, preferably 40% to 80% by weight and more preferably 40% to 60% by weight of monomers, preferably (meth)acrylates and/or components copolymerizable with (meth)acrylates,
0% to 40% by weight, preferably 5% to 30% by weight, of one or more prepolymers,
0% to 30% by weight, preferably to 15% by weight and more preferably to 10% by weight of crosslinkers, preferably selected from the group of the oligo- or di(meth)acrylates,
0% to 10% by weight, preferably 0.5% to 8% by weight and more preferably 3% to 6% by weight of initiators, for example photoinitiators, preferably in this case hydroxy ketones and/or bisacylphosphines.

The resin component preferably does not contain a crosslinker.

The notation “(meth)acrylates” encompasses both methacrylates and acrylates, and mixtures of methacrylates and acrylates.

In addition, still further components may optionally be present. Auxiliaries and additives used in addition may be chain transfer agents, plasticizers, stabilizers and/or inhibitors. In addition, it is possible to add dyes, fillers, wetting, dispersing and levelling aids, adhesion promoters, UV stabilizers, defoamers and rheology additives. More particularly, the resin component may contain the following additional constituents:
1% to 20% by weight of urethane (meth)acrylates.

It is crucial for the present invention that the monomers and/or prepolymers from the resin component have functional groups. Suitable functional groups of this kind are hydroxyl groups, amino groups and/or thiol groups which react in an addition reaction with the free isocyanate groups or uretdione groups from the isocyanate component and hence give additional crosslinking and curing. A hydroxy-functional resin component has, for example, an OH number of 10 to 1000, preferably 20 to 500 mg, more preferably of 20 to 150 mg KOH/gram.

More particularly, the amount of functional groups is chosen such that there are 0.6 to 2.0 isocyanate equivalents, or 0.3 to 1.0, preferably 0.4 to 0.8 and more preferably 0.45 to 0.55 uretdione group in the isocyanate component, for every functional group in the resin components. This corresponds to 0.6 to 2.0, preferably 0.8 to 1.6 and more preferably 0.9 to 1.1 externally blocked isocyanate groups in the isocyanate component.

Photoinitiators and the production thereof are described, for example, in “Radiation Curing in Polymer Science & Technology, Vol II: Photoinitiating Systems” by J. P. Fouassier and J. F. Rabek, Elsevier Applied Science, London and New York, 1993. These are frequently α-hydroxy ketones or derivatives thereof or phosphines. The photoinitiators may, if present, be present in amounts of 0.2% to 10% by weight. Examples of useful photoinitiators include Basf-CGI-725 (BASF), Chivacure 300 (Chitec), Irgacure PAG 121 (BASF), Irgacure PAG 103 (BASF), Chivacure 534 (Chitec), H-Nu 470 (Spectra Group limited), TPO (BASF), Irgacure 651 (BASF), Irgacure 819 (BASF), Irgacure 500 (BASF), Irgacure 127 (BASF), Irgacure 184 (BASF), Duracure 1173 (BASF).

Through the use of combinations of different initiators (for example two UV initiators, two different thermal or redox initiators or a combination of one UV initiator and one thermal or redox initiator) in the matrix, it was surprisingly possible to further improve the quality of the components/laminates. Through the use of polyols in the matrix with addition of combinations of various initiators (see above), it was surprisingly possible to improve the quality of the components/laminates once again. In this case, the residual monomer contents of the semi-finished product up to the component in the overall process were probably reduced in comparison, or the polymerization of the monomers proceeded more completely and the associated postpolymerization in the further process advantageously favoured this effect.

The monomers present in the reactive resin are compounds selected from the group of the (meth)acrylates, for example alkyl (meth)acrylates of straight-chain, branched or cycloaliphatic alcohols having 1 to 40 carbon atoms, e.g. methyl (meth)acrylate, ethyl (meth)acrylate, n-butyl (meth)acrylate or 2-ethylhexyl (meth)acrylate.

Suitable constituents of monomer mixtures also include additional monomers having a further functional group, such as α, β-unsaturated mono- or dicarboxylic acids, for example acrylic acid, methacrylic acid or itaconic acid; esters of acrylic acid or methacrylic acid with dihydric alcohols, for example hydroxyethyl (meth)acrylate or hydroxypropyl (meth)acrylate; acrylamide or methacrylamide; or dimethylaminoethyl (meth)acrylate. Further suitable constituents of monomer mixtures are, for example, glycidyl (meth)acrylate or silyl-functional (meth)acrylates.

As well as the (meth)acrylates detailed above, the monomer mixtures may also include further unsaturated monomers copolymerizable with the aforementioned (meth)acrylates by means of free-radical polymerization. These include 1-alkenes or styrenes.

An optional constituent of the inventive reactive resin is the crosslinkers. These are especially polyfunctional methacrylates such as allyl (meth)acrylate. Particular preference is given to di- or tri(meth)acrylates, for example 1,4-butanediol di(meth)acrylate, tetraethylene glycol di(meth)acrylate, triethylene glycol di(meth)acrylate or trimethylolpropane tri(meth)acrylate.

Specifically, the composition of the monomers in terms of content and composition will appropriately be chosen with regard to the desired technical function and the carrier material to be crosslinked.

The resin component may, as well as the monomers listed, also contain polymers, referred to as prepolymers in the context of this property right for better distinction, preferably polyesters or poly(meth)acrylates. These are used to improve the polymerization properties, the mechanical properties, the adhesion to the carrier material, the setting of the viscosity in the course of processing or wetting of the carrier material with the resin, and the optical properties of the resins. The prepolymer content of the reactive resin is between 0% by weight and 50% by weight, preferably between 15% by weight and 40% by weight. The poly(meth)acrylates may have additional functional groups for promotion of adhesion or for copolymerization in the crosslinking reaction, for example in the form of double bonds. Preferably, the prepolymers have hydroxyl, amine or thiol groups.

Said poly(meth)acrylates are generally composed of the same monomers as already listed with regard to the monomers in the resin system. They may be obtained by solution polymerization, emulsion polymerization, suspension polymerization, bulk polymerization or precipitation polymerization and are added to the system as a pure substance.

Said polyesters are obtained via bulk polycondensation or ring-opening polymerization and are composed of the monomer units known for these applications.

Chain transfer agents used may be any compounds known from free-radical polymerization. Preference is given to using mercaptans such as n-dodecyl mercaptan.

It is likewise possible to use conventional UV stabilizers. The UV stabilizers are preferably selected from the group of the benzophenone derivatives, benzotriazole derivatives, thioxanthonate derivatives, piperidinolcarboxylic ester derivatives or cinnamic ester derivatives. From the group of stabilizers or inhibitors, preference is given to using substituted phenols, hydroquinone derivatives, phosphines and phosphites.

Rheology additives used are preferably polyhydroxycarboxamides, urea derivatives, salts of unsaturated carboxylic acid esters, alkylammonium salts of acidic phosphoric acid derivatives, ketoximes, amine salts of p-toluenesulphonic acid, amine salts of sulphonic acid derivatives and aqueous or organic solutions or mixtures of the compounds. It has been found that rheology additives based on fumed or precipitated, optionally also silanized, silicas having a BET surface area of 10-700 nm²/g are particularly suitable.

Defoamers used are preferably selected from the group of alcohols, hydrocarbons, paraffin-based mineral oils, glycol derivatives, derivatives of glycolic esters, acetic esters and polysiloxanes.

### Polyols

A particular advantage of the inventive addition of the polyols is better processibility overall, a better bond between several layers of prepregs pressed together, and better homogenization of the matrix material over the entire moulding.

According to the invention, the composition, in addition to the methacrylate-based reactive resins, contains polyols which likewise enter into a crosslinking reaction with the isocyanate components, as OH-functional co-binders. By addition of these polyols which are unreactive in process step III, it is possible to more accurately adjust the rheology and hence the processing of the semi-finished products from process step III, and of the end products. For example, the polyols act as plasticizers, or more specifically as reactive diluents, in the semi-finished product from process step III. The polyols can be added in such a way that up to 80%, preferably up to 50%, of the OH functionalities of the reactive resin are replaced thereby.

Suitable OH-functional co-binders are in principle all polyols used customarily in PU chemistry, provided that the OH functionality thereof is at least two, preferably between three and six, with use of diols (difunctional polyols) only in mixtures with polyols having more than two OH functionalities. Functionality in the context of a polyol compound refers to the number of reactive OH groups in the molecule. For the end use, it is necessary to use polyol compounds having an OH functionality of at least 3 in order to form a three-dimensional dense network of polymer in the reaction with the isocyanate groups of the uretdiones. It is of course also possible to use mixtures of various polyols.

An example of a simple suitable polyol is glycerol. Other low molecular weight polyols are sold, for example, by Perstorp® under the Polyol®, Polyol® R or Capa® product names, by Dow Chemicals under the Voranol® RA, Voranol® RN, Voranol® RH or Voranol® CP product names, by BASF under the Lupranol® name and by DuPont under the Terathane® name. Details of specific products with specification of the hydroxyl numbers and the molar masses can be found, for example, in the German patent application having the priority reference 102014208415.6.

As an alternative to the low molecular weight polyols mentioned, it is also possible to use oligomeric polyols. These are, for example, linear or branched hydroxyl-containing polyesters, polycarbonates, polycaprolactones, polyethers, polythioethers, polyesteramides, polyurethanes or polyacetals, each of which are known per se, preferably polyesters or polyethers. These oligomers preferably have a number-average molecular weight of 134 to 4000. Particular preference is given to linear hydroxyl-containing polyesters—polyester polyols—or mixtures of such polyesters. They are prepared, for example, by reaction of diols with substoichiometric amounts of dicarboxylic acids, corresponding dicarboxylic anhydrides, corresponding dicarboxylic esters of lower alcohols, lactones or hydroxycarboxylic acids. Examples of suitable monomer units for such polyesters can likewise be found in the German patent application having priority reference 102014208415.6.

Oligomeric polyols used are more preferably polyesters having an OH number between 25 and 800, preferably between 40 and 400, an acid number of not more than 2 mg KOH/g and a molar mass between 200 and 4000 g/mol, preferably between 300 and 800 g/mol. The OH number is determined analogously to DIN 53 240-2, and the acid number analogously to DIN EN ISO 2114. The molar mass is calculated from the hydroxyl and carboxyl end groups.

With equal preference, polyethers are used as oligomeric polyols. These especially have an OH number between 25 and 1200 mg KOH/g, preferably between 40 and 1000 mg KOH/g, more preferably between 60 and 900 mg KOH/g, and a molar mass M_{w} between 100 and 2000 g/mol, preferably between 150 and 800 g/mol. An example of a particularly suitable polyether is Lupranol® 3504/1 from BASF Polyurethanes GmbH.

As a very particularly preferred example, oligomeric polyols used are polycaprolactones having an OH number between 25 and 540, an acid number between 0.5 and 1 mg KOH/g and a molar mass between 240 and 2500 g/mol. Suitable polycaprolactones are Capa 3022, Capa 3031, Capa 3041, Capa 3050, Capa 3091, Capa 3201, Capa 3301, Capa 4101, Capa 4801, Capa 6100, Capa 6200, Capa 6250, all from Perstorp, Sweden. It is of course also possible to use mixtures of the polycaprolactones, polyesters, polyethers and polyols.

### Curing in Process Step III

As stated, there are various technical options for curing the reactive resin without involvement of the polyols and the isocyanate component in process step III.

In a first alternative, the curing is effected thermally. For this purpose, peroxides and/or azo initiators are added to the reactive resin, which initiate the curing of the resin component as the temperature is increased to a breakdown temperature suitable for the respective initiator. Such initiators and the corresponding breakdown temperatures are common knowledge to those skilled in the art. Suitable initiation temperatures for such a thermal curing operation, in the process described, are preferably at least 20° C. above ambient temperature and at least 10° C. below the curing temperature of the isocyanate component in process step V. For example, a suitable initiation, for example in the case of onset of isocyanate crosslinking even at low temperatures, may be between 40 and 70° C. In general, an initiation temperature for the thermal initiation—with appropriate matched isocyanate components—between 50 and 110° C. is chosen.

A preferred alternative to a thermal initiation is what is called a redox initiation. This involves producing a two-component redox system consisting of an initiator, generally a peroxide, preferably dilauroyl peroxide and/or dibenzoyl peroxide, in the first component and an accelerator, generally an amine, preferably a tertiary aromatic amine, in a second component by mixing the two components. The mixing, which is generally effected as the last step in process step I., brings about an initiation which additionally enables impregnation in process step II., within an open window, generally between 10 and 40 min. Correspondingly, in the case of such an initiation which can be conducted at room temperature, process step II. has to be conducted within this open window after process step I.

The third alternative is a photoinitiation, for example by means of electromagnetic radiation (especially UV radiation), electron beams or a plasma.

UV curing and UV lamps are described, for example, in “Radiation Curing in Polymer Science & Technology, Vol I: Fundamentals and Methods” by J. P. Fouassier and J. F. Rabek, Elsevier Applied Science, London and New York, 1993, Chapter 8, pages 453 to 503. Preference is given to using UV lamps which emit little thermal radiation, if any at all, for example UV LED lamps.

Electron beam curing and curing agents are described, for example, in “Radiation Curing in Polymer Science & Technology, Vol I: Fundamentals and Methods” by J. P. Fouassier and J. F. Rabek, Elsevier Applied Science, London and New York, 1993, Chapter 4, pages 193 to 225, and in Chapter 9, pages 503 to 555. If electron beams are used to initiate polymerization, no photoinitiators are required.

The same applies to plasma applications. Plasmas are frequently used in vacuo. Plasma polymerization of MMA is described, for example, in the studies by C. W. Paul, A. T. Bell and D. S. Soong “Initiation of Methyl Methacrylate Polymerization by the Nonvolatile Products of a Methyl Methacrylate Plasma. 1. Polymerization Kinetics” (Macromolecules 1985, vol. 18, 11, 2312-2321). A vacuum plasma of this kind is used here.

According to the invention, the free radical source used in the present process is what is called an atmospheric pressure plasma. For this purpose, it is possible, for example, to use commercial plasma jets/plasma beams as supplied, for example, by Plasmatreat GmbH or Diener GmbH. The plasma operates under atmospheric pressure, and is used inter alia in the automobile industry for removal of greases or other contaminants on surfaces. In contrast to the plasma process described in the literature, the plasma, according to the invention, is produced outside the actual reaction zone (polymerization) and blown onto the surface of the composites to be treated at high flow velocity. This gives rise to a kind of “plasma flare”. The advantage of the process is that the actual plasma formation is not affected by the substrate, which leads to high process reliability. The plasma jets are normally operated with air, so as to form an oxygen/nitrogen plasma. In the plasma jets, the plasma is generated within the nozzle by an electrical discharge. The electrodes are electrically separated. A voltage sufficiently high for a spark to jump from one electrode to the other is applied. This results in discharge. It is possible to set a different number of discharges per unit time. The discharges can be effected by pulsing of a DC voltage. A further option is to achieve the discharges through an AC voltage.

After the prepreg has been produced on the fibre with the aid of radiation or plasmas in process step III., this product can be stacked and shaped. This is followed by the final crosslinking with the aid of heat. According to the use and amount of catalysts, this crosslinking is effected at temperatures between 80 and 220° C. and 72 h and 5 sec, preferably at temperatures between 140 and 200° C. and with curing times of 1 min to 30 min. Preference is given to application of an external pressure during the crosslinking.

The polymer compositions used in accordance with the invention give very good levelling in the case of low viscosity, and hence good impregnatability and, in the cured state, excellent chemical resistance. In the case that aliphatic crosslinkers are used, for example IPDI or H₁₂MDI, and through the inventive use of the functionalized poly(meth)acrylates, good weathering resistance is additionally achieved.

The semi-finished composites produced in accordance with the invention additionally have very good storage stability under room temperature conditions, generally for several weeks or even months. They can be processed further at any time to give composite components. This is the essential difference from the prior art systems, which are reactive and not storage-stable, since they begin to react, for example to give polyurethanes, and hence to crosslink immediately after application.

Thereafter, the storable semi-finished composites can be processed further at a later juncture to give composite components. Use of the inventive semi-finished composites results in very good impregnation of the fibrous carrier, as a result of the fact that the liquid resin components containing the isocyanate component give very good wetting of the fibres of the carrier, with avoidance, through prior homogenization of the polymer composition, of the thermal stress on the polymer composition that can lead to commencement of a second crosslinking reaction; in addition, the process steps of grinding and screening into individual particle size fractions are dispensed with, such that a higher yield of impregnated fibrous carrier can be achieved.

A further great advantage of the semi-finished composites produced in accordance with the invention is that the high temperatures as required at least briefly in the melt impregnation process or in the partial sintering of pulverulent reactive polyurethane compositions are not absolutely necessary in this process according to the invention.

### Particular Aspects of the Process According to the Invention

Process step II, the impregnation, is effected by soaking the fibres, woven fabrics or laid scrims with the formulation produced in process step I. Preference is given to effecting the impregnation at room temperature.

Process step III, the curing of the resin component, directly follows process step II. The curing is effected for example by irradiation with electromagnetic radiation, preferably UV radiation, electron beams or by applying a plasma field. It should be ensured here that the temperature is below the curing temperature required for process step V.

The semi-finished composites/prepregs produced in accordance with the invention have very high storage stability at room temperature after process step III or IV. According to the reactive polyurethane composition present, they are stable at least for a few days at room temperature. In general, the semi-finished composites are storage-stable at 40° C. or lower for several weeks, and also at room temperature over several years. The prepregs thus produced are not tacky and therefore have very good handling and further processibility. The reactive or highly reactive polyurethane compositions used in accordance with the invention accordingly have very good adhesion and distribution on the fibrous carrier.

In process step IV, the semi-finished composites/prepregs thus produced can be combined to give different shapes and cut to size as required. More particularly, two or more semi-finished composites are consolidated to give a single composite before final crosslinking of the matrix material to give the matrix by cutting the semi-finished composites to size, and optionally sewing or fixing them in some other way.

In process step V, the final curing of the semi-finished composites is effected to give mouldings which have been crosslinked to give a thermoset. This is effected by thermal curing of the functional group, preferably of the hydroxyl groups of the resin component 1 with the isocyanate component.

In the context of this invention, this operation of production of the composite components from the prepregs, according to the curing time, is effected at temperatures above about 160° C. with use of reactive matrix materials (variant I), or in the case of high-reactivity matrix materials provided with appropriate catalysts (variant II) at temperatures above 80° C., especially above 100° C. More particularly, the curing is conducted at a temperature between 80 and 200° C., more preferably at a temperature between 120 and 180° C.

In the curing in process step V, the semi-finished composites can additionally be compressed in a suitable mould under pressure and with optional application of reduced pressure.

The reactive polyurethane compositions used in accordance with the invention are cured under standard conditions, for example with DBTL catalysis, at or above 160° C., typically at or above about 180° C. The reactive polyurethane compositions used in accordance with the invention give very good levelling, and hence good impregnatability and, in the cured state, excellent chemical resistance. When aliphatic crosslinkers (e.g. IPDI or H12MDI) are used, good weathering resistance is additionally achieved.

With the aid of the high-reactivity isocyanate component used in accordance with the invention, which cures at low temperature, it is possible at a curing temperature of 80 to 160° C. not just to save energy and curing time, but it is also possible to use many thermally sensitive carriers.

The uretdione-containing polyurethane compositions of the second embodiment are cured in process step Vat temperatures of 80 to 160° C., according to the nature of the carrier. Preferably, this curing temperature is 120 to 180° C., more preferably 120 to 150° C.; especially preferably, the temperature for curing is within a range between 130 and 140° C. The time for curing of the polyurethane composition used in accordance with the invention is within 5 to 60 minutes.

However, it is also possible to use specific catalysts to accelerate the reaction in the second curing operation in process step V, for example quaternary ammonium salts, preferably carboxylates or hydroxides, more preferably in combination with epoxides or metal acetylacetonates, preferably in combination with quaternary ammonium halides. These catalyst systems can ensure that the curing temperature for the second curing operation drops down to 100° C., or else that shorter curing times are required at higher temperatures.

### Further Constituents of the Prepregs

In addition to the resin component, the carrier material and the isocyanate component, the semi-finished composites may include further additives. For example, it is possible to add light stabilizers, for example sterically hindered amines, or other auxiliaries as described, for example, in EP 669 353, in a total amount of 0.05% to 5% by weight. Fillers and pigments, for example titanium dioxide, may be added in an amount of up to 30% by weight of the overall composition. For the production of the reactive polyurethane compositions of the invention, it is additionally possible to add additives such as levelling agents, for example polysilicones, or adhesion promoters, for example based on acrylate.

The invention also provides for the use of the prepregs, especially having fibrous carriers composed of glass fibres, carbon fibres or aramid fibres. The invention especially also provides for the use of the prepregs produced in accordance with the invention for production of composites in boat- and shipbuilding, in aerospace technology, in automobile construction, for two-wheeled vehicles, preferably motorcycles and pedal cycles, in the automotive, construction, medical technology and sports sectors, the electrical and electronics industry, and in energy generation installations, for example for rotor blades in wind turbines.

The invention also provides the mouldings or composite components produced from the semi-finished composites or prepregs produced in accordance with the invention, formed from at least one fibrous carrier and at least one crosslinked reactive composition, preferably a crosslinked reactive composition containing uretdione groups, comprising a (meth)acrylate resin and polyols as matrix.

### EXAMPLES

The following glass fibre scrims/fabrics were used in the examples:

Glass filament fabric 296 g/m²-Atlas, Finish FK 144 (Interglas 92626)

The polyol used in the inventive examples is Polyol 4290 from Perstorp. This polyol is tetrafunctional, and has a hydroxyl number of 290±20 mg KOH/g and a molecular weight of about 800 g/mol.

### Preparation of the Uretdione-Containing Curing Agent CA:

119.1 g of IPDI uretdione (Evonik Degussa GmbH) were dissolved in 100 ml of methyl methacrylate, and 27.5 g of methylpentanediol and 3.5 g of trimethylolpropane were added. After adding 0.01 g of dibutyltin dilaurate, the mixture was heated to 80° C. while stirring for 4 h. Thereafter, no free NCO groups were detectable any longer by titrimetric methods. The curing agent CA has an effective latent NCO content of 12.8% by weight (based on solids).

### Reactive Polyurethane Composition

Reactive polyurethane compositions having the formulations which follow were used for production of the prepregs and the composites (see tables).

### Comparative Example 1

### Corresponding to the Teaching from EP 2 661 459

TABLE 1

| | | Proportion | |
|---|---|---|---|
| Component | Function | (% by wt.) | Manufacturer |
| Curing agent CA | uretdione-containing | 53.3 | |
| (60% in MMA) | curing agent | | |
| (effective NCO: 7.7%) | component a) | | |
| Hydroxypropyl | OH-containing | 14.0 | Evonik |
| acrylate | monomer | | Industries AG |
| Laminating resin C | methacrylate resin | 8.2 | Evonik |
| | | | Industries AG |
| Methyl methacrylate | monomer | 22.7 | Evonik |
| (MMA) | | | Industries AG |
| Dibenzoyl peroxide | initiator | 0.9 | Fluka |
| N,N-bis(2-Hydroxy- | accelerator | 0.9 | Aldrich |
| ethyl)- | | | |
| p-toluidine | | | |

The feedstocks from Table 1 were mixed in a premixer to form a solution of the solid constituents in the monomers. This mixture can be used within about 2 to 3 h before it gelates.

To produce the prepregs, the glass fibre fabric was impregnated with the solution of the matrix materials. The prepregs were dried to constant weight in an oven at temperatures of 60° C. for 30 min. The proportion by mass of fibres was 47% by weight. The impregnated glass fibre mats were compressed at 180° C. and 50 bar for 1 h (press: Polystat 200 T from Schwabenthan) and fully crosslinked in the process. The hard, stiff, chemical-resistant and impact-resistant composite components (sheet material) had a T_{g} of 119° C.

### Comparative Example 2

### Corresponding to the Teaching from PCT/EP2014/053705

TABLE 2

| | | Proportion | |
|---|---|---|---|
| Component | Function | (% by wt.) | Manufacturer |
| Curing agent CA | uretdione-containing | 53.3 | |
| (60% in MMA) | curing agent | | |
| (effective NCO: 7.7%) | component a) | | |
| Hydroxypropyl | OH-containing | 14.0 | Evonik |
| acrylate | monomer | | Industries AG |
| Laminating resin C | methacrylate resin | 8.2 | Evonik |
| | | | Industries AG |
| Methyl methacrylate | monomer | 22.7 | Evonik |
| (MMA) | | | Industries AG |
| Irgacure 819 | photoinitiator | 1.8 | Ciba |

The feedstocks from Table 2 were mixed in a premixer to form a solution of the solid constituents in the monomers. This mixture can be stored for about 1 to 2 years without gelation.

To produce the prepregs, the glass fibre fabric was impregnated with the solution of the matrix materials. The prepregs were irradiated at 1.5 m/min with a UV-LED lamp (Heraeus NobleCure® based on water-cooled heat sink, wavelength: 395±5 nm, power density: 8 W/cm² at working distance 5 mm, emission window: 251×35 mm²) and dried in the process. The proportion by mass of fibres was 54% by weight. The impregnated glass fibre mats were compressed at 180° C. and 50 bar for 1 h (press: Polystat 200 T from Schwabenthan) and fully crosslinked in the process. The hard, stiff, chemical-resistant and impact-resistant composite components (sheet material) had a Tg of 123° C.

### Comparative Example 3

### Corresponding to the Teaching from PCT/EP2014/053705

TABLE 3

| | | Proportion | |
|---|---|---|---|
| Component | Function | (% by wt.) | Manufacturer |
| Curing agent CA | uretdione-containing | 63.0 | |
| (60% in MMA) | curing agent | | |
| (effective NCO: 7.7%) | component a) | | |
| Hydroxypropyl | OH-containing | 14.0 | Evonik |
| acrylate | monomer | | Industries AG |
| Isobornyl | monomer | 21.0 | Evonik |
| methacrylate | | | Industries AG |
| Irgacure 819 | photoinitiator | 2.0 | Ciba |

The feedstocks from Table 3 were mixed in a premixer to form a solution of the solid constituents in the monomers. This mixture can be stored for at least 1 to 2 days without gelation.

To produce the prepregs, the glass fibre fabric was impregnated with the solution of the matrix materials. The prepregs were irradiated at 1.5 m/min with a UV-LED lamp (Heraeus NobleCure® based on water-cooled heat sink, wavelength: 395±5 nm, power density: 8 W/cm² at working distance 5 mm, emission window: 251×35 mm²) and dried in the process. The proportion by mass of fibres was 50% by weight. The impregnated glass fibre mats were compressed at 170° C. and 15 bar for 1 h (press: Polystat 200 T from Schwabenthan) and fully crosslinked in the process. The hard, stiff, chemical-resistant and impact-resistant composite components (sheet material) had a Tg of 98° C. Interlaminar shear strength of the laminate was 15 MPa.

### Example 1

TABLE 4

| | | Proportion | |
|---|---|---|---|
| Component | Function | (% by wt.) | Manufacturer |
| Curing agent CA | uretdione-containing | 74.0 | |
| (60% in MMA) | curing agent | | |
| (effective NCO: 7.9%) | component a) | | |
| Hydroxypropyl | OH-containing | 11.0 | Evonik |
| methacrylate | monomer | | Industries AG |
| Polyol 4290 | polyol | 13.0 | Perstop |
| Dibenzoyl peroxide | initiator | 2.0 | Fluka |

The feedstocks from Table 4 were mixed in a premixer to form a solution of the solid constituents in the monomers. This mixture can be used within about 24 hours before it gelates.

To produce the prepregs, the glass fibre fabric was impregnated with the solution of the matrix materials and then rolled up together in a film sandwich. The supply of film prevented contact of air with the matrix. However, there are only slight differences in this regard from the comparative tests. Corresponding performance of the comparative tests gave products having a somewhat lower fibre content and a tendency toward an increase in glass transition temperature of the matrix material by a few degrees Celsius.

The prepregs together with the film were polymerized in an oven at a temperature of 60° C. for 60 min. The proportion by mass of fibres was determined in Example 1 to be 40%. The impregnated glass fibre mats were compressed at 170° C. and 15 bar for 1 h (press: Polystat 200 T from Schwabenthan) and fully crosslinked in the process. The hard, stiff, chemical-resistant and impact-resistant composite components (sheet material) had a Tg of 105° C. Interlaminar shear strength of the laminate was 71 MPa.

### Example 2

TABLE 5

| | | Proportion | |
|---|---|---|---|
| Component | Function | (% by wt.) | Manufacturer |
| Curing agent CA | uretdione-containing | 74.0 | |
| (60% in MMA) | curing agent | | |
| (effective NCO: 7.9%) | component a) | | |
| Hydroxypropyl | OH-containing | 11.0 | Evonik |
| methacrylate | monomer | | Industries AG |
| Polyol 4290 | polyol | 13.0 | Perstop |
| Dibenzoyl peroxide | initiator | 1.0 | Fluka |
| Irgacure 819 | photoinitiator | 1.0 | Ciba |

The feedstocks from Table 5 were mixed in a premixer to form a solution of the solid constituents in the monomers. This mixture can be used for several hours with exclusion of light at room temperature before it gelates.

To produce the prepregs, the glass fibre fabric was impregnated with the solution of the matrix materials and then rolled up together in a film sandwich. Then the prepregs together with the film were irradiated at 1.5 m/min with a UV-LED lamp (Heraeus NobleCure® based on water-cooled heat sink, wavelength: 395±5 nm, power density: 8 W/cm² at working distance 5 mm, emission window: 251×35 mm²) and dried in the process. Subsequently, further polymerization was effected in an oven at a temperature of 60° C. for 30 min. The proportion by mass of fibres was determined in Example 2 to be a content of 40% by weight.

The impregnated glass fibre mats were compressed at 170° C. and 15 bar for 1 h and fully crosslinked in the process. The hard, stiff, chemical-resistant and impact-resistant composite components (sheet material) had a Tg of 120° C.

Comparing the comparative examples to the inventive examples, the following improvements were achieved:
1. Lowering the pressure from 50 Pa (comparative examples) to 15 Pa in the inventive examples
2. Improving the interlaminar shear strength (ILSS) from 15 MPa in the comparative examples to 71 in the inventive examples
3. Achieving higher glass transition temperatures with simultaneously lower melt viscosities.

1. A process for producing a semi-finished composite and further processing thereof to give a moulding, said process comprising:
I. producing a reactive composition,
II. directly impregnating a fibrous carrier with the composition from I.,
III. curing the resin component in the composition by thermal initiation, redox initiation of a two-component system, electromagnetic radiation, electron beams or a plasma,
IV. shaping to give the moulding and
V. curing an isocyanate component in the composition,
wherein the composition comprises:
A) a reactive (meth)acrylate-based resin component, wherein at least one constituent of the resin component has a hydroxyl, amine and/or thiol group,
B) at least one di- or polyisocyanate which has been internally blocked and/or blocked with a blocking agent as isocyanate component, and
C) one or more polyols which are not (meth)acrylates or poly(meth)acrylates.

2. The process according to claim 1, wherein the composition contains 25% to 85% by weight of the resin component, 10% to 60% by weight of the isocyanate component and 3% by weight to 40% by weight of one or more polyols.

3. The process according to claim 1, wherein the resin component comprises at least
0% by weight to 30% by weight of crosslinker,
30% by weight to 100% by weight of monomers, and
0% by weight to 40% by weight of poly(meth)acrylates.

4. The process according to claim 1, wherein the resin component comprises at least
2% by weight to 10% by weight of di- or tri(meth)acrylates,
40% by weight to 60% by weight of (meth)acrylate monomers,
0% by weight to 20% by weight of urethane (meth)acrylates,
5% by weight to 30% by weight of poly(meth)acrylates, and
0% by weight to 10% by weight of photoinitiator, peroxide and/or azo initiator.

5. The process according to claim 1, wherein the composition contains 10% by weight to 40% by weight of the polyol, and wherein the polyol is a low molecular weight polyol having 3 to 6 OH functionalities, a polyester having a molecular weight Mₙ between 200 and 4000 g/mol, an OH number between 25 and 800 mg KOH/g and an acid number less than 2 mg KOH/g, a polyether having an OH number between 25 and 1200 mg KOH/g and a molar mass M_{w} between 100 and 2000 g/mol, or a mixture of at least two of these polyols.

6. The process according to claim 5, wherein the polyester is a polycaprolactone having an OH number between 25 and 540, an acid number between 0.5 and 1 mg KOH/g and a molar mass between 240 and 2500 g/mol.

7. The process according to claim 1, wherein the fibrous carriers comprise for the most part at least one member selected from the group consisting of glass, carbon, polymers, natural fibres, and mineral fibre materials, and
wherein the fibrous carriers take the form of at least one selected from the group consisting of sheetlike textile structures made from nonwoven fabric, knitted fabric, non-knitted structures, and of long-fibre or short-fibre materials.

8. The process according to claim 1, wherein di- or polyisocyanates are at least one selected from the group consisting of isophorone diisocyanate (IPDI), hexamethylene diisocyanate (HDI), diisocyanatodicyclohexylmethane (H12MDI), 2-methylpentane diisocyanate (MPDI), 2,2,4-trimethylhexamethylene diisocyanate/2,4,4-trimethylhexamethylene diisocyanate (TMDI) and/or norbornane diisocyanate (NBDI), including the isocyanurates, and are used as isocyanate component, and
wherein said di- or polyisocyanates have been blocked with at least one external blocking agent selected from the group consisting of ethyl acetoacetate, diisopropylamine, methyl ethyl ketoxime, diethyl malonate, ε-caprolactam, 1,2,4-triazole, phenol or substituted phenols and 3,5-dimethylpyrazole.

9. The process according to claim 1, wherein the isocyanate component additionally contains 0.01% to 5.0% by weight of a catalyst

10. The process according to claim 1, wherein the isocyanate components used are uretdiones prepared from isophorone diisocyanate hexamethylene diisocyanate (HDI), diisocyanatodicyclohexylmethane (H12MDI), 2-methylpentane diisocyanate (MPDI), 2,2,4-trimethylhexamethylene diisocyanate/2,4,4-trimethylhexamethylene diisocyanate (TMDI) and/or norbornane diisocyanate (NBDI).

11. The process according to claim 10, wherein the isocyanate component is in solid form below 40° C. and in liquid form above 125° C., has a free NCO content of less than 5% by weight and a uretdione content of 3% to 50% by weight, and
wherein the isocyanate component additionally contains 0.01% to 5% by weight of at least one catalyst selected from the group consisting of quaternary ammonium salts, quaternary phosphonium salts and mixtures thereof with halogens, hydroxides, alkoxides or organic or inorganic acid anions as counterion.

12. The process according to claim 10, wherein the isocyanate component additionally contains 0.1% to 5% by weight of at least one cocatalyst selected from either
at least one epoxide and/or at least one metal acetylacetonate and/or quaternary ammonium acetylacetonate and/or quaternary phosphonium acetylacetonate, and optionally auxiliaries and additives known from polyurethane chemistry.

13. The process according to claim 1, wherein the resin component, the polyols and the isocyanate component are present in such a ratio to one another that there is 0.3 to 1.0 uretdione group for every hydroxyl group in the resin component and the polyol.

14. The process according to claim 1, wherein the curing of the isocyanate component in process step V. is conducted at a temperature between 80 and 200° C.

15. A moulding produced from a semi-finished composite according to claim 1, formed from at least one fibrous carrier and at least one crosslinked reactive composition containing a cured (meth)acrylate resin, as matrix.

16. (canceled)
